(19) United States
(12) Patent Application Publication
(10) Pub. No.: US 2026/0317094 A1
(43) Pub. Date: Oct. 15, 2026

(54) APPARATUS FOR DISCHARGING TRANSPORT CONTAINER

(71) Applicant: SK ON CO., LTD., Seoul (KR)

(72) Inventors: Se Young LEE, Daejeon (KR); Moon Sang YOU, Daejeon (KR); Ji Yun YANG, Daejeon (KR)

(21) Appl. No.: 19/557,119

(22) Filed: Mar. 5, 2026

(30) Foreign Application Priority Data
Apr. 10, 2025 (KR) 10-2025-0046677

(51) Int. Cl. B65G 69/06; B65G 65/23; B65G 65/40

(52) U.S. Cl. CPC B65G 69/06; B65G 65/23; B65G 65/40; B65G 2812/1658; B65G 2812/1691; B65G 2814/0319; B65G 2814/0326

(57) ABSTRACT

An apparatus for discharging a transport container includes a transport container including a receiving portion having a storage space for storing a material therein, a first opening provided at an upper portion thereof, and a pallet portion provided below the receiving portion and securing a space between the receiving portion and a ground, and a pressure supply portion connected to the first opening and supplying pressurized gas to the transport container. The pressure supply portion includes a pressurized gas supply portion supplying the pressurized gas, and a pressure regulation portion provided between the pressurized gas supply portion and the first opening and regulating pressure of the pressurized gas.

### CROSS-REFERENCE TO RELATED APPLICATIONS

This patent document claims the priority and benefits of Korean Patent Application No. 10-2025-0046677 filed on Apr. 10, 2025, the disclosure of which is incorporated herein by reference in its entirety.

### TECHNICAL FIELD

The disclosure and implementations disclosed in this patent document generally relate to an apparatus for discharging a transport container.

### BACKGROUND

Intermediate Bulk Container (IBC) transport containers are industrial containers used to transport and store bulk materials such as liquids, semi-solids, and powders.

Typically, transport containers are made of plastic, metal, or composite materials, and include a pallet-shaped substructure, facilitating transportation using forklifts, cranes, or hand lifts, and are chemically resistant and durable, and are used to transport and store hazardous materials inside and also used to transport and store hazardous materials therein due to excellent chemical resistance and durability thereof.

### SUMMARY

The present disclosure can be implemented in some embodiments to provide an apparatus for discharging a transport container, which may more safely discharge a material stored in the transport container.

In addition, according to an aspect of the present disclosure, an apparatus for discharging a transport container, which may more quickly discharge a material stored in the transport container, is provided.

Furthermore, according to an aspect of the present disclosure, an apparatus for discharging a transport container is provided, which may be widely applied to devices within green technology fields such as electric vehicles, battery charging stations, and other battery-powered solar and wind power generation.

In some embodiments of the present disclosure, an apparatus for discharging a transport container includes the transport container including a receiving portion having a storage space for storing a material therein, a first opening provided at an upper portion thereof, and a pallet portion provided below the receiving portion and securing a space between the receiving portion and a ground, and a pressure supply portion connected to the first opening and supplying pressurized gas to the transport container. The pressure supply portion includes a pressurized gas supply portion supplying the pressurized gas, and a pressure regulation portion provided between the pressurized gas supply portion and the first opening and regulating pressure of the pressurized gas.

In an embodiment, the pressurized gas may be compressed air obtained by filtering and compressing atmospheric air.

In an embodiment, the pressure regulation portion may include a pressure regulating valve regulating the pressure of the pressurized gas supplied from the pressurized gas supply portion to a constant level and supplying the pressurized gas to the transport container.

In an embodiment, the pressure regulation portion may include a pressure safety valve opening at a preset pressure.

In an embodiment, the receiving portion may include a second opening provided by penetrating through a lower portion of a side surface of the receiving portion, and the apparatus for discharging a transport container may further include a discharge portion comprising a pump suctioning and discharging the material stored in the receiving portion through the second opening.

In an embodiment, the discharge portion may further include a check valve provided between the pump and the second opening and preventing a discharged material from flowing back into the transport container.

In an embodiment, the pump may be a diaphragm pump.

In an embodiment, the apparatus for discharging a transport container may include a transport container adjustment portion including a height adjustment portion disposed on one side of the transport container, including a prop configured to be inserted into the pallet portion and an elevating portion for raising and lowering the prop, and adjusting a height of one side of the transport container.

In an embodiment, the transport container adjustment portion may include a support portion provided opposite the height adjustment portion with the transport container interposed therebetween, and restricting movement of the transport container.

In an embodiment, the support portion may include a sloped surface sloping away from the transport container as a surface thereof facing the transport container increases in a direction of a height of the transport container, based on a ground.

In an embodiment, the receiving portion may include a second opening provided by penetrating through a lower portion of a side surface of the receiving portion, and the support portion may be provided as a pair of support portions spaced apart from each other with the second opening interposed therebetween.

In an embodiment, the transport container adjustment portion may include a first safety bar facing the support portion with the transport container therebetween, and disposed between the transport container and the height adjustment portion.

In an embodiment, the first safety bar may be provided between an end of the prop and the elevating portion, and the elevating portion may include an adjustment space configured to permit raising and lowering of the prop.

In an embodiment, the transport container adjustment portion may further include a second safety bar disposed between the support portion and the first safety bar, and the support portion, the first safety bar, and the second safety bar may respectively support different side surfaces of the transport container.

### BRIEF DESCRIPTION OF DRAWINGS

Certain aspects, features, and advantages of the present disclosure are illustrated by the following detailed description with reference to the accompanying drawings.

FIG. 1 is a conceptual diagram of an apparatus for discharging a transport container according to an embodiment.

FIG. 2 is a perspective view of a transport container according to an embodiment.

FIG. 3 is a side view of a joint according to an embodiment.

FIG. 4 is a plan view of a transport container adjustment portion according to an embodiment.

FIG. 5 is a side view of a transport container adjustment portion according to an embodiment.

### DETAILED DESCRIPTION

Features of the present disclosure disclosed in this patent document are described by example embodiments with reference to the accompanying drawings.

Before proceeding with a detailed description of the present disclosure, it should be noted that the terms and words used in this specification and claims should not be construed as limited to their conventional or dictionary meanings. Based on the principle that inventors may appropriately define the concepts of terms to best describe their inventions, the terms should be interpreted in a way that aligns with the technical spirit of the present disclosure. Therefore, the embodiments described in this specification and the configurations depicted in the drawings represent only the appropriate example embodiments and do not fully represent the technical spirit of the present disclosure. Therefore, it should be understood that various equivalents and modifications may exist at the time of filing.

Hereinafter, example embodiments will be described in detail with reference to the accompanying drawings. It should be noted that in the attached drawings, identical components are represented by identical symbols as much as possible. Furthermore, detailed descriptions of well-known functions and configurations that may obscure the gist of the present disclosure will be omitted. For the same reason, some components in the accompanying drawings are exaggerated, omitted, or schematically depicted, and the dimensions of respective components do not fully reflect the actual size. For example, in this specification, expressions such as upper side, upper, upward, lower side, lower, downward, side surface, and the like are explained based on the illustration in the drawing, and may be expressed differently if the direction of the object is changed.

Hereinafter, the present disclosure will be described in detail with reference to the attached drawings. However, these are merely illustrative and the present disclosure is not limited to the detailed embodiments illustrated as examples.

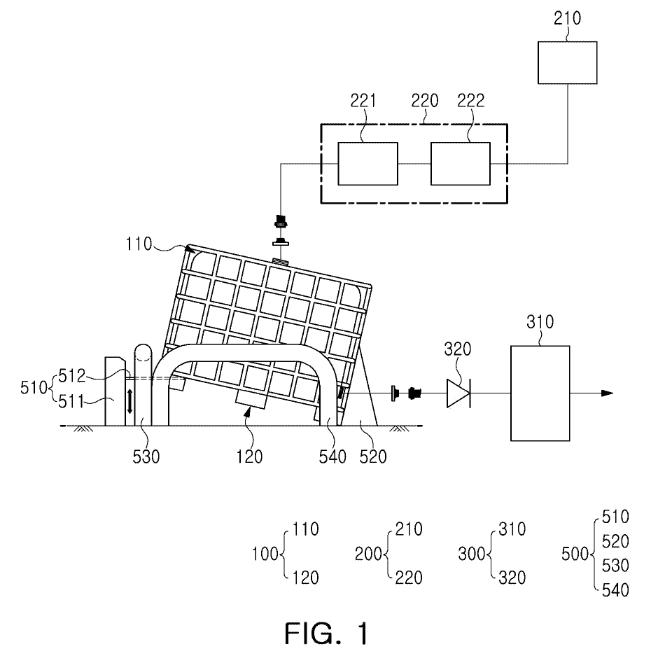

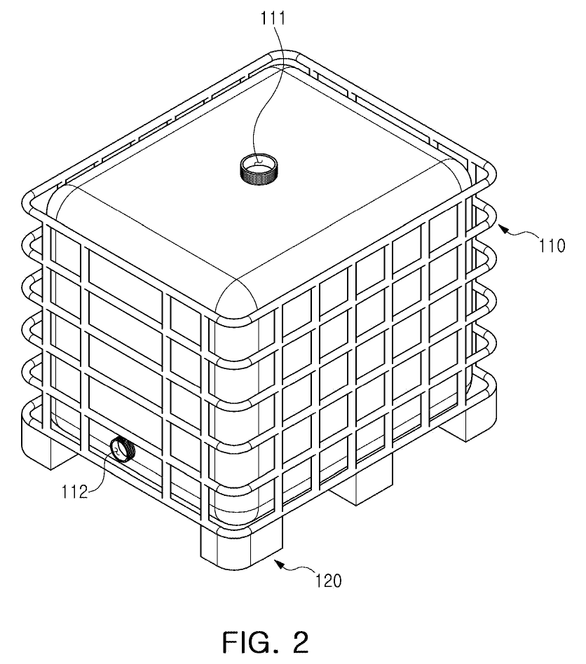

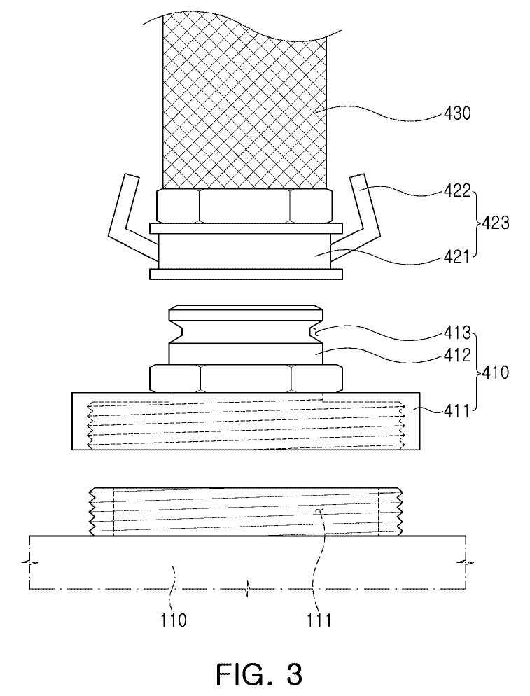

FIG. 1 is a conceptual diagram of an apparatus 1 for discharging a transport container according to an embodiment, FIG. 2 is a perspective view of a transport container 100 according to an embodiment, and FIG. 3 is a side view of a joint according to an embodiment.

Referring to FIG. 1, an apparatus 1 for discharging a transport container according to an embodiment includes a transport container 100 that includes a receiving portion 110 having a receiving space capable of storing a material therein and a first opening 111 provided at an upper portion thereof, and a pallet portion 120 provided below the receiving portion 110 to secure a space between the receiving portion 110 and the ground, and a pressure supply portion 200 connected to the first opening 111 and supplying pressurized gas to the transport container 100. The pressure supply portion 200 may include a pressurized gas supply unit 210 that supplies the pressurized gas, and a pressure regulation portion 220 provided between the pressurized gas supply portion 210 and the first opening 111 to control the pressure of the pressurized gas.

In this case, the material stored in the receiving space may be a hazardous material such as N-Methyl-2-pyrrolidone (NMP) or Carbon Nanotube (CNT), and may be stored in a liquid form.

The apparatus 1 for discharging a transport container may include a discharge portion 300 for discharging the material contained in the transport container 100, and the pressure supply portion for increasing the decreasing pressure of the transport container 100 as the material is discharged.

In more detail, referring to FIG. 2, the transport container 100 may include the receiving portion 110 for storing the material therein, and the pallet portion 120 provided below the receiving portion 110.

The receiving portion 110 forms an internal receiving space and may store the material in the receiving space.

The pallet portion 120 may include a space between the receiving portion 110 and the ground, into which a gripper of a forklift or hand lift may be inserted, thereby transporting the receiving portion 110 using the forklift or hand lift.

In this case, the transport container 100 may be an IBC container or a pallet container.

The transport container 100 may include a first opening 111 provided in the upper surface and a second opening 112 provided on the lower portion of at least one of the side surfaces.

Referring again to FIG. 1, in an apparatus 1 for discharging a transport container according to an embodiment, the first opening 111 and the pressure supply portion may be connected, and the discharge portion 300 may be connected via the second opening 112.

Therefore, the discharge portion 300 discharges the material inside the transport container 100 at high speed through the second opening 112, while the pressure supply portion connected through the first opening 111 provides pressurized gas into the transport container 100, thereby preventing a vacuum from forming in the transport container 100.

The pressure supply portion 200 may include a pressurized gas supply portion 210 that supplies pressurized gas having a predetermined pressure to the receiving portion 110 of the transport container 100, and a pressure regulation portion 220 provided between the pressurized gas supply portion 210 and the first opening 111.

The pressurized gas supply portion 210 may be a pressure tank storing pressurized gas. Alternatively, the pressurized gas supply portion 210 may be a pressurized air pipe used in a place (for example, a factory) where the apparatus 1 for discharging a transport container according to an embodiment is installed, and may be connected to a pipe branched from the pressurized air pipe to receive pressurized gas.

In this case, the pressurized gas may be gas supplied from a pressure tank or a pressurized air pipe. The pressurized gas may be compressed air obtained by filtering and compressing atmospheric air. In particular, the pressurized gas supplied from the pressurized air pipe may be air compressed after undergoing primary filtering of atmospheric air.

Meanwhile, an additional filter may be included between the pressurized gas supply portion 210 and the pressure regulation portion 220 to remove foreign materials contained in the compressed gas, thereby preventing contamination of the internal materials of the transport container 100.

The pressure regulation portion 220 may include a pressure safety valve 221 that opens at a preset pressure.

In this case, the pressure safety valve 221 may be a PSV (Pressure Safety Valve) or Pressure Relief Valve (PRV), and the pressure regulating valve 222 may be a regulator.

The pressure safety valve 221 may prevent the transport container 100 from bursting due to pressurized gas supplied from the pressurized gas supply portion 210 at excessive pressure.

For example, if the pressure regulating valve 222 malfunctions and high-pressure gas is supplied to the transport container 100, the pressure safety valve 221 may reduce the pressure before the transport container 100 bursts.

The pressure regulation portion 220 may include a pressure regulating valve 222 regulating the pressure of the pressurized gas supplied from the pressurized gas supply portion 210 to a constant level and supplying the pressurized gas to the transport container 100.

The pressure regulating valve 222 may regulate the pressure of the pressurized gas supplied from the pressurized gas supply portion 210 to supply the pressurized gas to the transport container 100 at a constant pressure.

For example, if the pressurized gas supply portion 210 branches off from the pressurized air line of the factory, the pressure of the pressurized air used in the factory is too high to be supplied to the transport container 100, which may excessively increase the internal pressure of the transport container 100. Furthermore, if the material stored in the transport container 100 is a hazardous material, there is a risk of a safety accident.

Therefore, the pressure regulation portion 220 may stably provide a constant pressure to the transport container 100, regardless of the pressure of the pressurized gas of the pressurized gas supply portion 210.

The apparatus 1 for discharging a transport container according to an embodiment may include the pressurized gas supply portion 210 and the pressure regulation portion 220, thereby supplying pressurized gas to the transport container 100 and thus preventing damage to the transport container 100 due to excessive pressurized gas supplied to the transport container 100, or damage to the transport container 100 due to a vacuum generated by discharge of internal materials within the transport container 100.

The apparatus 1 for discharging a transport container according to an embodiment may include the second opening 112 formed by penetrating through the lower portion of a side surface of the receiving portion 110, and the discharge portion 300 including a pump 310 suctioning and discharging a material stored in the receiving portion 110 through the second opening 112.

The discharge portion 300 may further include a check valve, which is provided between the pump 310 and the second opening 112, to prevent discharged material from flowing back into the transport container 100.

The discharge portion 300 may include the pump 310 that sucks up material stored in the storage space of the transport container 100 and discharges the material to another location, and the check valve 320 that is provided between the second opening and the pump 310 and prevents material sucked from the transport container 100 by the pump 310 from returning to the transport container 100.

The discharge portion 300 uses the pump 310 to suck up and discharge the material inside the transport container 100, thereby transporting the material inside the transport container 100 to another destination at high speed.

In this case, the pump 310 may be a diaphragm pump.

The apparatus 1 for discharging a transport container according to an embodiment may safely transport corrosive hazardous materials using a diaphragm pump.

The discharge portion 300 may include a check valve between the second opening 112 and the pump 310, thereby preventing fluid from flowing back into the transport container 100.

The first opening 111 and the pressure regulation portion 220, and the second opening 112 and the discharge portion 300 may be connected via a sealing joint 400.

In this case, referring to FIG. 3, the first opening 111 and the second opening 112 may have a cylindrical single-tube shape protruding outward from the receiving portion 110 and may have a spiral groove along the outer circumference thereof. Accordingly, during the transport process, the first opening 111 and the second opening 112 may be coupled and sealed to caps that rotate and have an inner groove corresponding to the spiral groove.

The sealing joint 400 may include a first joint 410 and a second joint 420.

The first joint 410 may be connected to the first opening 111 or the second opening 112, and the second joint 420 may be connected to the end of a flexible hose 423 connected to the pressure regulation portion 220 or the discharge portion 300. The first joint 410 and the second joint 420 may have a detachable structure.

In more detail, the first joint 410 may include a body portion 411 that may be connected to the first opening 111 or the second opening 112, and an adapter 412 that protrudes outward by penetrating through the body portion 411 and includes a concave portion 413 along the outer circumference.

Additionally, the second joint 420 may be connected to the end of a flexible hose 423 connected to the pressure regulation portion 220 or the discharge portion 300, and may include a coupler 421 into which the adapter 412 of the first joint 410 may be inserted, and a lever 422 which has one side in contact with the concave portion 413 of the adapter 412 and which may be adjusted to bring the adapter 412 into contact with a gasket (not shown) provided inside the coupler 421.

For example, the body portion 411 of the first joint 410 may have an internal screw thread to be coupled with the first opening 111. With the first joint 410 coupled to the first opening 111, the second joint 420 may be provided such that the adapter 412 protruding outwardly from the body portion 411 is inserted into the coupler 421, and the lever 422 is tilted toward the flexible hose 423, thereby enabling the adapter 412 to be brought into close contact with the gasket provided inside the coupler 421 and thus coupling the first joint 410 and the second joint 420 to each other.

However, the present disclosure is not limited thereto, and for example, after removing the sealing caps provided on the first opening 111 and the second opening 112 of the transport container 100, the first opening 111 and the second opening 112 may be sealed and connected. Various types of couplings that prevent internal materials from leaking between the first opening 111 and the second opening 112 and the flexible hose 423 may be applied.

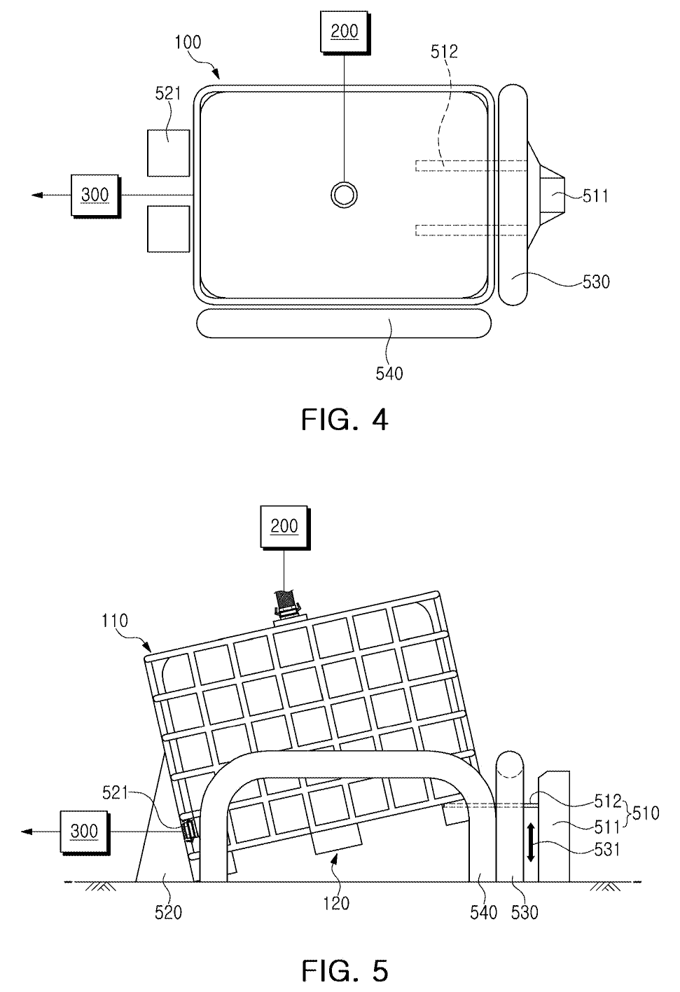

FIG. 4 is a plan view of a transport container adjustment portion 500 according to an embodiment, and FIG. 5 is a side view of the transport container adjustment portion 500 according to an embodiment.

Referring to FIGS. 4 and 5, the apparatus 1 for discharging a transport container according to an embodiment may further include the transport container adjustment portion 500 that supports the transport container 100 and significantly reduces the residual amount of material contained within the transport container 100.

In more detail, the apparatus 1 for discharging a transport container according to an embodiment may include a transport container adjustment portion 500 having a height adjustment portion 510, which is disposed on one side of the transport container 100 and has a prop 512 inserted into a pallet portion 120 and an elevating portion 511 raising and lowering the prop 512 to adjust the height of one side of the transport container 100.

The transport container adjustment portion 500 may include the height adjustment portion 510, which has a prop 512 at least partially inserted into the pallet portion 120 of the transport container 100 and the elevating portion 511 supporting the prop 512 and raising and lowering the prop 512 and which adjusts the height of one side of the transport container 100 to tilt the transport container 100.

In this case, the elevating portion 511 may be an actuator operated by pneumatic or hydraulic pressure, and the prop 512 may be raised and lowered by pneumatic or hydraulic pressure.

The transport container adjustment portion 500 may include a support portion 520 facing the height adjustment portion 510 with the transport container 100 interposed therebetween and restricting movement of the transport container 100.

The support portion 520 may include a sloped surface 521 sloping away from the transport container 100 as the surface facing the transport container 100 increases in the height direction of the transport container 100 based on the ground.

The support portion 520 includes the sloped surface 521 that is inclined at a predetermined angle from the ground, thereby overall supporting and stably supporting the side surface of the transport container 100 tilted by the height adjustment portion 510.

Furthermore, the support portion 520 may be provided as a pair of support portions which are disposed to be spaced apart from each other with the second opening 112 interposed therebetween.

In more detail, the pair of support portions 520 may include the sloped surface 521 at a predetermined angle on the side facing the transport container 100, thereby stably supporting the tilted transport container 100.

Additionally, the second opening 112 of the transport container 100 may be configured to be disposed in the space between a pair of support portions 520, and the second opening 112 and the discharge portion 300 may be connected between the pair of support portions 520 so as not to interfere with the support portion 520.

Accordingly, the height of one side of the transport container 100 is raised by the height adjustment portion 510 provided on the other side of the support portion 520, so that the material inside the transport container 100 may be collected toward the support portion 520, in more detail, toward the second opening 112, and the discharge portion 300 may discharge the material inside the transport container 100 so that a residual amount inside the transport container 100 may be minimal.

The transport container adjustment portion 500 according to an embodiment may include a first safety bar 530 and a second safety bar 540.

The transport container adjustment portion 500 may include a first safety bar 530 disposed between the transport container 100 and the support portion 520, and disposed between the transport container 100 and the height adjustment portion 510.

The first safety bar 530 is provided between the end of the prop 512 and the elevating portion 511, and the elevating portion 511 may include an adjustment space 531 through which the prop 512 may be raised and lowered.

The first safety bar 530 may protect the height adjustment portion 510 from being damaged by collision with the height adjustment portion 510 during the process of moving the transport container 100.

In addition, the first safety bar 530 may further include an adjustment space through which the prop 512 of the height adjustment portion 510 may pass and move up and down, thereby protecting the height adjustment portion 510 while allowing the height adjustment portion 510 to adjust the height of one side of the transport container 100.

The first safety bar 530 protecting the height adjustment portion 510 may be provided spaced apart from the support portion 520, and the first safety bar 530 and the support portion 520 may be disposed at a distance at least sufficient to allow the transport container 100 to be inserted.

The transport container adjustment portion 500 may further include a second safety bar 540 disposed between the support portion 520 and the first safety bar 530. The support portion 520, the first safety bar 530, and the second safety bar 540 may respectively support different side surfaces of the transport container 100.

The second safety bar 540 may guide the transport container 100 to a position where it may be stably tilted by the height adjustment portion 510 while discharging the material therein.

In more detail, the first safety bar 530, the second safety bar 540, and the support portion 520 may be disposed in a form with one side being open and three sides of the transport container 100 being surrounded in the plan view.

The transport container 100 may be transported and safely disposed through the open side surface where the first safety bar 530, the second safety bar 540, and the support portion 520 are not disposed. In this case, the transport container 100 may be moved to contact or near the second safety bar 540, allowing the second opening 112 to naturally be positioned in the space between the pair of support portions 520. Furthermore, the prop of the height adjustment portion 510 may be tilted toward one side of the transport container 100, thereby guiding the transport container 100 to be disposed in a position that prevents the transport container from tipping over during adjusting of the height of the transport container 100.

Therefore, in a process of transporting the transport container 100 into the transport container adjustment portion 500, a separate alignment process may be omitted by disposing the transport container 100 between the first safety bar 530, the second safety bar 540, and the support bar.

Meanwhile, in an apparatus 1 for discharging a transport container of the related art, by connecting the pump 310 through the first opening 111 provided at the top of the transport container 100, when transporting the material inside the transport container 100, foreign materials may enter the transport container 100 through the first opening 111.

Furthermore, if the material inside the transport container 100 is a volatile hazardous material, there is a risk that the hazardous material may leak through the open first opening 111, posing a safety risk to workers.

In addition, when the apparatus 1 for discharging a transport container according to the related art transports the material inside the transport container 100 through the second opening 112 provided at the lower portion of the transport container 100, the transfer portion may be distorted due to the generation of an internal vacuum when transporting at high speeds. In addition, equipment such as a forklift is required to tilt the transport container 100 to prevent residual quantity, requiring a large work space.

In contrast, the apparatus 1 for discharging a transport container according to an embodiment of the present disclosure may rapidly discharge the material inside the transport container 100 using the discharge portion 300 connected to the second opening 112.

Furthermore, the apparatus 1 for discharging a transport container according to an embodiment may safely discharge the material inside the transport container 100 by significantly reducing pressure changes within the transport container 100 during the process of rapidly discharging the material inside the transport container 100 using the pressure supply portion 200 connected to the first opening 111.

Furthermore, the apparatus 1 for discharging a transport container according to an embodiment may minimize the residual amount inside the transport container 100 after discharging the material inside using the discharge portion 300 connected to the second opening 112 by tilting the transport container 100 using the height adjustment portion 510.

Furthermore, the apparatus 1 for discharging a transport container according to an embodiment may tilt the transport container 100 using the pallet portion 120 provided on the transport container 100 without a separate device installed below the transport container 100. Therefore, in cases where space is limited, the transport container 100 may be disposed in the transport container adjustment portion 500 using a hand lift, thereby significantly reducing the workspace required.

In detail, when hazardous materials are stored inside the transport container 100, the apparatus 1 for discharging a transport container according to an embodiment may significantly reduce the time required for safe work by discharging the materials inside the transport container 100 while the transport container 100 is sealed. Furthermore, by discharging the materials inside the transport container 100 using the pump 310, the time required for transferring the materials inside the transport container 100 may be significantly reduced.

As set forth above, an apparatus for discharging a transport container according to an embodiment may more safely discharge materials stored in a transport container.

Furthermore, an apparatus for discharging a transport container according to an embodiment may more quickly discharge materials stored in the transport container.

Only specific examples of implementations of certain embodiments are described. Variations, improvements and enhancements of the disclosed embodiments and other embodiments may be made based on the disclosure of this patent document. In addition, the above-described embodiments may be implemented by deleting some components, and the respective embodiments may be implemented in combination with each other.

What is claimed is:

1. An apparatus for discharging a transport container, comprising:
a transport container including a receiving portion having a storage space for storing a material therein, a first opening provided at an upper portion thereof, and a pallet portion provided below the receiving portion and securing a space between the receiving portion and a ground; and
a pressure supply portion connected to the first opening and supplying pressurized gas to the transport container,
wherein the pressure supply portion includes,
a pressurized gas supply portion supplying the pressurized gas; and
a pressure regulation portion provided between the pressurized gas supply portion and the first opening and regulating pressure of the pressurized gas.

2. The apparatus of claim 1, wherein the pressurized gas is compressed air obtained by filtering and compressing atmospheric air.

3. The apparatus of claim 1, wherein the pressure regulation portion includes a pressure regulating valve regulating the pressure of the pressurized gas supplied from the pressurized gas supply portion to a constant level and supplying the pressurized gas to the transport container.

4. The apparatus of claim 3, wherein the pressure regulation portion includes a pressure safety valve opening at a preset pressure.

5. The apparatus of claim 1, wherein the receiving portion includes a second opening provided by penetrating through a lower portion of a side surface of the receiving portion,
wherein the apparatus for discharging a transport container further includes a discharge portion comprising a pump suctioning and discharging the material stored in the receiving portion through the second opening.

6. The apparatus of claim 5, wherein the discharge portion further includes a check valve provided between the pump and the second opening and preventing a discharged material from flowing back into the transport container.

7. The apparatus of claim 6, wherein the pump is a diaphragm pump.

8. The apparatus of claim 1, wherein the apparatus for discharging a transport container includes a transport container adjustment portion including a height adjustment portion disposed on one side of the transport container, including a prop configured to be inserted into the pallet portion and an elevating portion for raising and lowering the prop, and adjusting a height of one side of the transport container.

9. The apparatus of claim 8, wherein the transport container adjustment portion includes a support portion provided opposite the height adjustment portion with the transport container interposed therebetween, and restricting movement of the transport container.

10. The apparatus of claim 9, wherein the support portion includes a sloped surface sloping away from the transport container as a surface thereof facing the transport container increases in a direction of a height of the transport container, based on a ground.

11. The apparatus of claim 9, wherein the receiving portion includes a second opening provided by penetrating through a lower portion of a side surface of the receiving portion, and
the support portion is provided as a pair of support portions spaced apart from each other with the second opening interposed therebetween.

12. The apparatus of claim 9, wherein the transport container adjustment portion includes a first safety bar facing the support portion with the transport container therebetween, and disposed between the transport container and the height adjustment portion.

13. The apparatus of claim 12, wherein the first safety bar is provided between an end of the prop and the elevating portion, and the elevating portion includes an adjustment space configured to permit raising and lowering of the prop.

14. The apparatus of claim 12, wherein the transport container adjustment portion further includes a second safety bar disposed between the support portion and the first safety bar, and
the support portion, the first safety bar, and the second safety bar respectively support different side surfaces of the transport container.
